(19) United States
(12) Patent Application Publication
(10) Pub. No.: US 2011/0227853 A1
(43) Pub. Date: Sep. 22, 2011

(54) Self-service digital table-top menu ordering device

(76) Inventor: Kena Warûngû, Cambridge, MA (US)

(21) Appl. No.: 13/065,004

(22) Filed: Mar. 11, 2011

Related U.S. Application Data
(60) Provisional application No. 61/312,759, filed on Mar. 11, 2010.

(51) Int. Cl. G06F 3/041

(52) U.S. Cl. 345/173

(57) ABSTRACT

The invention presented here is a Self-Service Digital Table-Top Menu Ordering Device is intended to be an easy to use comprehensive one-stop shop tool self-service table top tool. Existing menu service based devices are single-standing kiosks and or hand held ordering devices which do not cater for special needs. Such services do not cater for the vision limited; the deaf and or persons with hand or limited finger mobility. This invention claims a state of the art stand-alone wireless touch screen with accessories for special needs and with capable of hosting digital menus usable in dining places or related self-service for seated at-table clients. The device is capable of communicating with a primary computer system through a wireless Wi-Fi system and or wired network system. The embodiment herein is not limited to these needs or current technologies but carries the aspirations expressed to the best of its intentions.

### CROSS-REFERENCES TO RELATED APPLICATIONS

Priority is claimed to U.S. provisional application No. 61/312,759, filed Mar. 11, 2010 and entitled “Self-Service Digital Table-Top Menu Ordering Device,” which is incorporated herein by reference in its entirety.

### STATEMENT REGARDING FEDERALLY SPONSORED RESEARCH OR DEVELOPMENT

Not Applicable.

### NAMES OF PARTIES TO A JOINT RESEARCH AGREEMENT

Not Applicable

### REFERENCE TO A “SEQUENCE LISTING,” A TABLE, OR A COMPUTER PROGRAM LISTING APPENDIX

Not Applicable

### BACKGROUND OF THE INVENTION

1. Field of the Invention

This invention relates generally to a set of touch screen devices for self-service or minimally assisted utility service especially In the service industry. More particularly, the invention is an effective tool in the hospitality service industry and related areas in allowing guests with special communication challenges to select what service they want to order for. This increases real-time data management efficiency in the same operational areas with respect to order management.

2. Description of Related Art

Self-service touch screen devices exist for different purposes. The service industry uses stand-alone or big computer monitors for the staff to deliver orders. Existing drive-through monitors or express LCD or Touch screen monitors for people to use in selecting services do not cater for at table services. Users have to walk to the device, select the service order from a screen and go take a seat or drive to the order receiving areas. These devices have not evolved enough to cater for people with special needs in the service industry and related self-service areas. Small Touch Screen devices include cell phones and tablets. Use and application of these devices vary but the main ones are voice and text data communication.

A vacuum exists in having a device at service tables that seated people can use to select what they want to order directly with the order receiving point. Intermediary device use only makes the staff work easier by relaying the order to the receiving point. This does not cater for the actual seated guests to order directly. Experience shows there are still ordering errors through intermediaries even when they are equipped with the device. Real time service is manual and it could be improved through real-time orders. To make the invention meet such challenges, a state of the art Wi-Fi communication technology is embodied in the device of invention cited herein.

As of this time, the existing menu service based devices are single standing kiosks and/or hand held ordering devices which do not cater to people with special needs. Such available devices do not cater for guest self-service either. Neither do they seem to cater for people with special needs at the same time with regular people's needs. The special needs persons in this category are the blind, the deaf, persons with limited fore-limb mobility, legally blind or those hard of hearing. A device integrating these special needs persons' service with a regular touch screen device is lacking.

Current existing restaurant and hotel food ordering menu service is in form of traditional paper-based menu or the self-service stand-alone kiosks for customers in some hotels. Other digital menu options in existence are for nutrition calculation used by customers before ordering. Portable hand-held ordering and credit card devices exist in some restaurants but these are used by waiters only. They do not cater for customers' self-service at table.

### BRIEF SUMMARY OF THE INVENTION

In accordance with this invention, the device integrates a set of existing tools into one self service unit for utilization in the restaurant, dining and at table. It brings to the service table the menu self-selection services for often neglected special needs like the blind or people with visual-limitation, the deaf, and people with limited finger or hand use. The device is not limited to in-house use. Rather the claim made on the applicability herewith is in broad terms deployable to claimed utility without limitations to space and with the assumption that communication adaptation is done by experts in that area.

The invention further relates to small computer devices with all the commonly known electronic units like the motherboard with its components, the Hard Disk, Read Access Memory (RAM), the Processor, the communication channels, facilitative accessories and heat management, the user interface in terms of a touch screen. In addition to these hardware components, the device embodies a Wi-Fi communication technology. It is enabled for installation of a relevant operating system and application software of user choice. In the light of industry lacking a publicly available device for people with communication challenges when ordering for services, such persons and those associated with them often have to forego their rightful services. Or they sacrifice their independence when ordering for meals or other such services that they would have been able to get if there was a device like the one in this claim.

### BRIEF DESCRIPTION OF THE DRAWINGS ON THE INVENTION

The present invention will be fully understood by reference to the following drawings which are for illustrative purposes only.

FIG. 1 shows the potential communication in Wi-Fi Local Area Network (Wi-Fi LAN) where the claimed device of this application is expected to work under.

FIG. 2 is an exhibit of the device from different views.

FIG. 2 A shows the basic front view of the Self-Service Digital Table-Top Menu Ordering Device, Touch screen menu options and accessories.

This is a front View tilted vertically on the stand.

FIG. 3 shows a scaled back view of the present object of invention: The Self-Service Digital Table-Top Menu Device. This shows alternative vertical positioning of the device on a table.

FIG. 4 shows a scaled back vertical positioning view of the present with arrows showing ventilation area, the Lithium Battery pack enclosure and the USB power adapter for charging the device battery. This excludes parts shown in FIG. 3

FIG. 5 represents a special remote control unit that accompanies the Braille Menu Pad (It is to be understood that this is not drawn to scale but elaborated to demonstrate the basic non-exclusive layout or content of the remote control). It is to be understood that a fully functional remote control would have to be modeled on the Braille Menu.

FIG. 6 demonstrates without limitations a possible Restaurant Touch Screen Menu on the device. The potential main menu contents illustrated are exhibited as FIGS. 6 (A)-FIG. 8 (I).

FIG. 7 is an illustration of the Braille Menu Pad and how it fits in the claim made.

FIG. 8 is a Braille pad rolled on the Braille Bridge connected to the Braille adapter and the remote control. This is a back view of the connected units with at upward slanted angle of the touch screen. Braille bridge for the Remote control attachment along with the actual Braille and the Touch screen Frame.

FIG. 9 Braille Storage against the Touch Screen back.

Flowcharts logistics presented with sequential numericals and narrative

FIG. 10 is Flow chart no. 1.on Menu Ordering system for persons varying vision needing zooming

FIG. 11 is a Flow chart no. 2 showing Braille Operation (For persons who are totally blind)

Braille menu pad activation through finger touch.

FIG. 12 is Flow chart no. 3 on the Device applicability in ordering system for the deaf.

FIG. 13. is Flow chart no. 4 on Menu Ordering system for visionary challenged but not completely blind.

FIG. 14 is Flow chart no. 5 on Menu Ordering system for persons with limited forelimb mobility.

FIG. 15 is Flow chart no. 6 on Menu Ordering system for persons with no speech challenges and does not have limited finger/or hand mobility.

FIG. 15 is Flow chart no. 6 on Menu Ordering system for persons with no speech challenges and does not have limited finger/or hand mobility.

FIG. 15 is Flow chart no. 6 on Menu Ordering system for persons with no speech challenges and does not have limited finger/or hand mobility.

### DETAILED DESCRIPTION OF THE INVENTION

As used throughout this document, the words “comprising,” “including,” and “having” are intended to set forth certain items, steps, elements, or aspects of something in an open-ended fashion. Although certain embodiments are disclosed herein, it is understood that these are provided by way of example only and the invention is not limited to these particular embodiments.

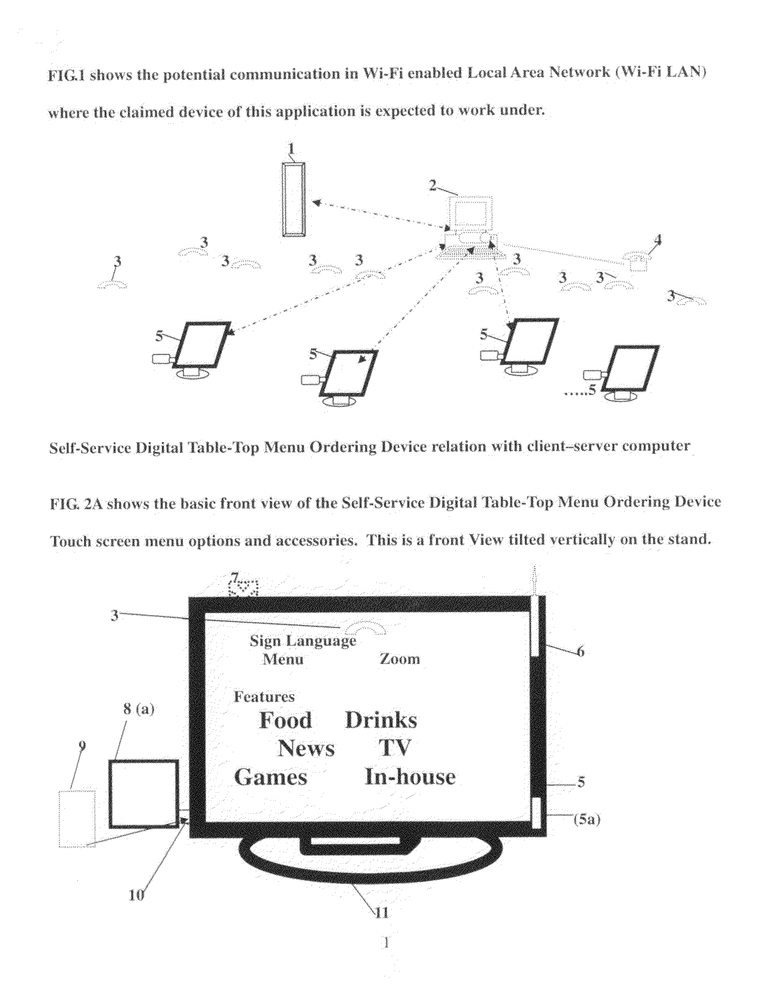

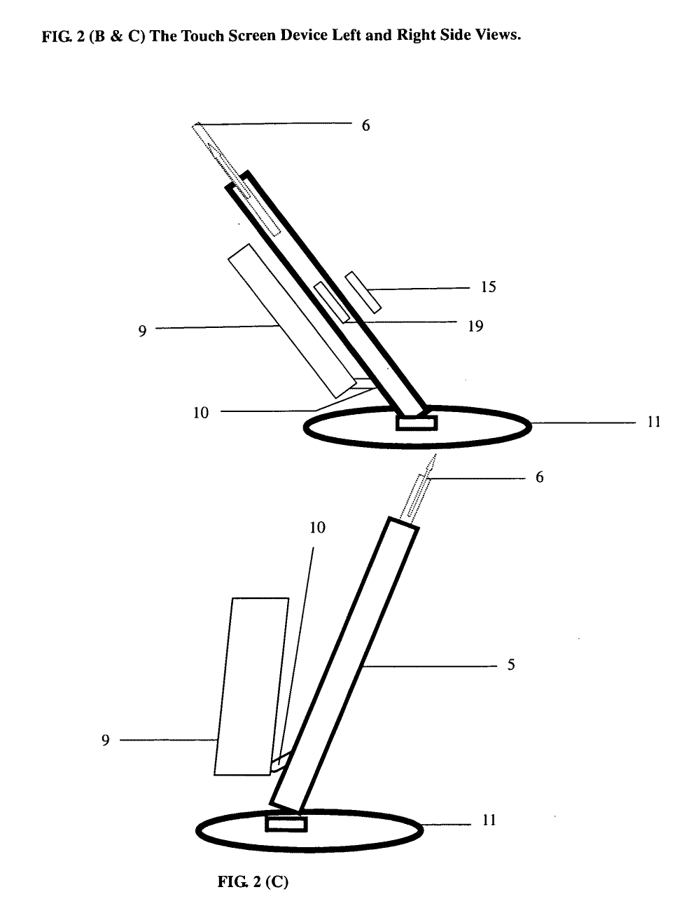

The invention brings together a table based digital touch screen menu ordering system for all persons including those with vision, hearing and limited hand or fingers mobility. While the software interface of this device is not included in this claim, the device can host small device operating system, related application software combined with a gaming service and online transactions by way of portable devices interne services and pay-card slot as one unit. The device manufacture and shipment comes with the touch screen options depicted in the drawings accompanied in the drawings in FIG. 2. Those skilled in the technology presented here will recognize the integration and usage of the claim as a one-stop shop for almost all at table in ordering for food or participating in self-service at table.

Accordingly, the claim made brings together in-existent and existing isolated resources as one integrated device that caters for a more equitable at table service. It allows people to have a more direct ordering system by using the menu on the device and communicating that directly to the order taking computer. This foregoes the current situation where a human server comes to the guest takes a menu for clients to select, takes orders and then delivers the orders to the order receiving and feedback station.

Accordingly, another objective of this invention is to improve current service ordering which is often characterized by communication barriers between the person ordering and the person taking orders; more time is taken in clarifying orders through such intermediaries. Research made in the industry show that many ordering services do not even carry paper menus for people with disabilities like seeing or hearing. Such persons often need a person to intervene in their ordering. Businesses often may have to hire a person capable of using special communications skills like Braille or Sign Language. Persons with special needs tend to have limited access to independent self-service ordering because the current tools and resources have not been tailored towards their needs. Other advantages of one or more aspects of this claim will become apparent from a consideration of the drawings, charts and descriptions presented herewith.

Further objects, advantages and specifications on this invention will become evident in the brief descriptions by way of drawings, explanations, and the detailed description of invention as a full disclosure on the object of inventions and its broad applications without any limitations thereon.

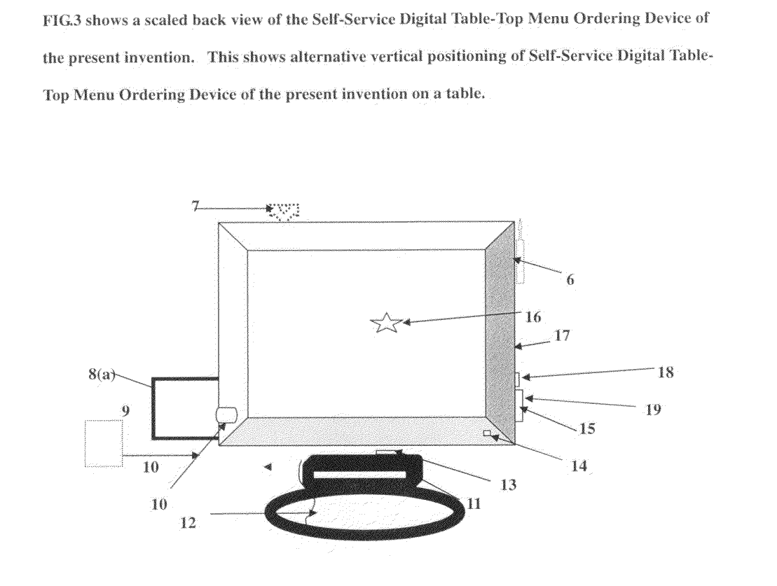

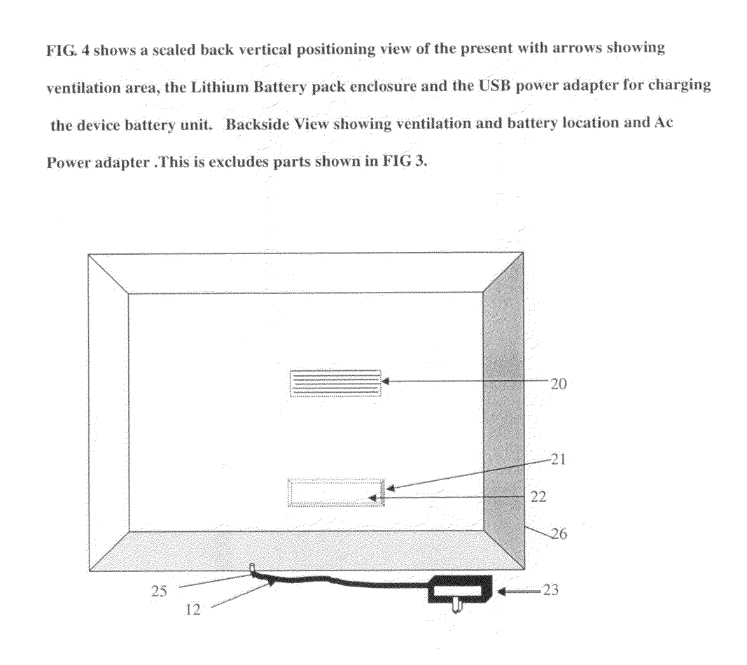

Persons of ordinary skill in the art will realize the description presented here on the invention is illustrative only and that it is in no way limiting. Other embodiments of the invention will readily suggest themselves to such skilled persons as may have the benefits of this disclosure. The invention presented is embodied in the apparatus illustrated in FIG. 1, FIG. 2, FIG. 3, FIG. 4 and FIG. 5 is a device within the hospitality industry customer service facilitating-devices. It will be appreciated that the apparatus presented may vary as to configuration and some of the details of the parts. The device of invention is presented in general terms as a self-service table top ordering device even though other uses may present themselves to persons of ordinary skill in the art. Specifically, FIG. 1 demonstrates the possible environment that the invention may operate in. FIG. 1 therefore a demonstration of how the invention herein labeled a no. 5 within the above mentioned figures communicates with other devices in the Wi-Fi enabled Local Area Network (Wi-Fi LAN).

Referring to FIG. 1 and the numeral reference, this is a presentation of a possible Network architecture. It presents a computer that serves as a server, a client, hot-spot, Wi-Fi signals and the device of invention acclaimed herein. The dotted lines represent the intangible digital signals likely to transpire between the devices when communication between them is activated. The number of items connected or communicating within the Wi-Fi LAN is a factor of Network design which is beyond the scope of this invention. However, the unit of invention is adaptable to Hot-Spot signal strength.

Networked computer technology requires that there is planning in the way devices, equipment and related tools communicate be compatible and synchronize. The programs and customization to meet the smooth effective running a network service is expected to be created in the environment that this invention will operate in. This is possible by persons skilled in network architecture planning and implementation.

Like any computer network common in various working environments, the server, the client and the device of invention with its accessories are expected to be tested and approved for the service it is meant for. This planning and test is not subject of this invention but rather an indication that the effective use will be realized if applied and employed by a person with the skill in the art.

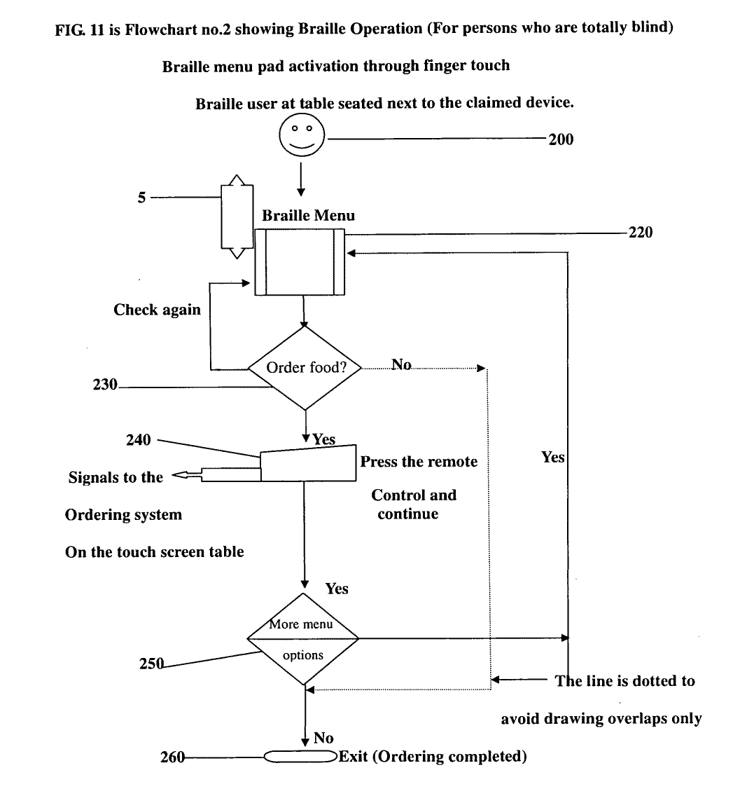

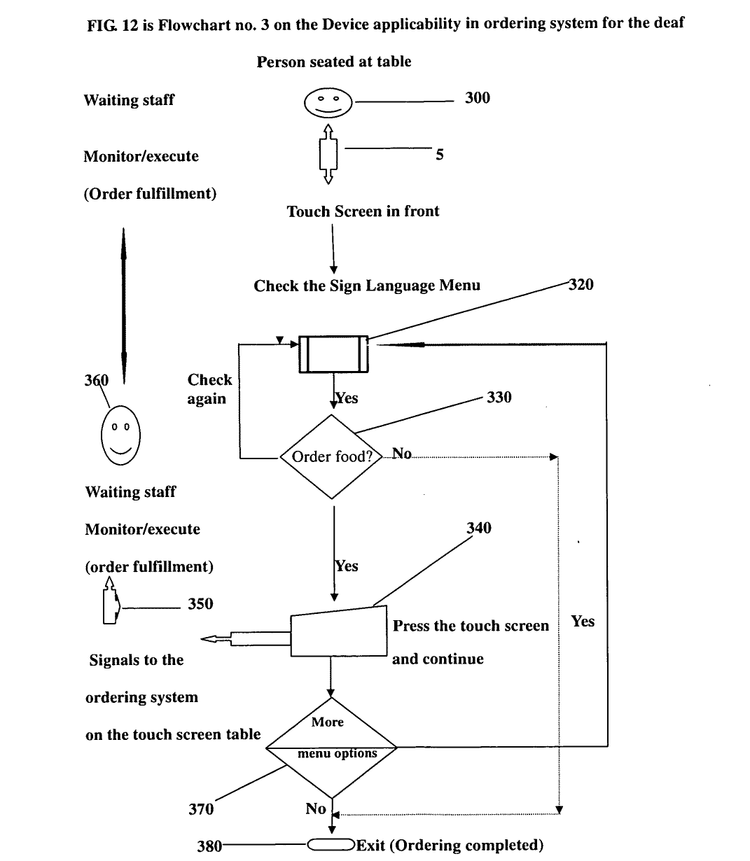

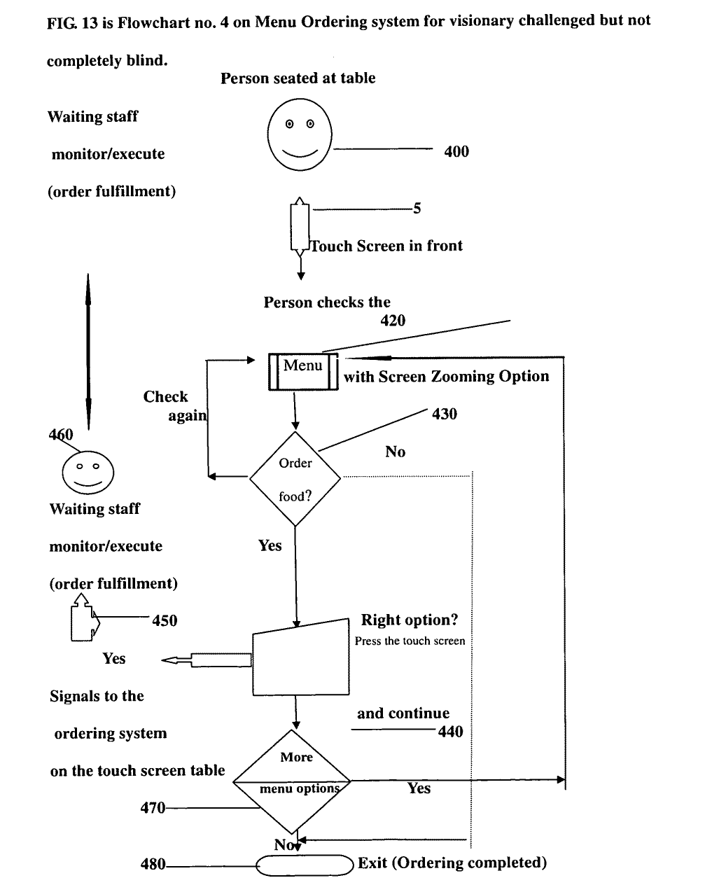

Referring to FIG. 1, FIG. 2, FIG. 3 and FIG. 4, the invention exhibits unique accessories embodied within no. 5. The accessories and on-screen options present its unique diverse services to persons with special needs and regular persons without those special limitations aforementioned in the Summary and advantages. The primary device labeled no. 5 is the touch screen device exhibited in FIG. 2 and FIG. 3 from its frontal view. The device has accessory no. 8 which is the Braille pad connected to no. 5 through a Braille Bridge so often referred in this document as the Braille Connector. This connector is connected to no. 5 from the side. The Braille Bridge may be technically adapted to connect to other Braille menu devices which are not subjects of this claim. The Braille pad referred to as no. 8 is itself designed in Braille language for the blind persons. The use of such Braille pad is demonstrated in FIG. 11 Flowchart. 2 showing without limitation the broad logistic principles involved in using the invention as it applies to such persons who may blind. It is to be noted that the primary role for the Braille Pad is to present the menu offerings as exhibited in FIG. 7. The selection and communicating the orders to be made is done through the Braille Remote control unit shown in FIG. 5 attached to the unit again through the Braille Bridge. The Remote control keys correspond to menu offerings being offered to persons being hosted. To the extent that one scrolls through the Braille pad, decides on what to order and presses the remote control number. It shows that the Braille Remote control operates on the same principles as a regular commonly used TV remote control.

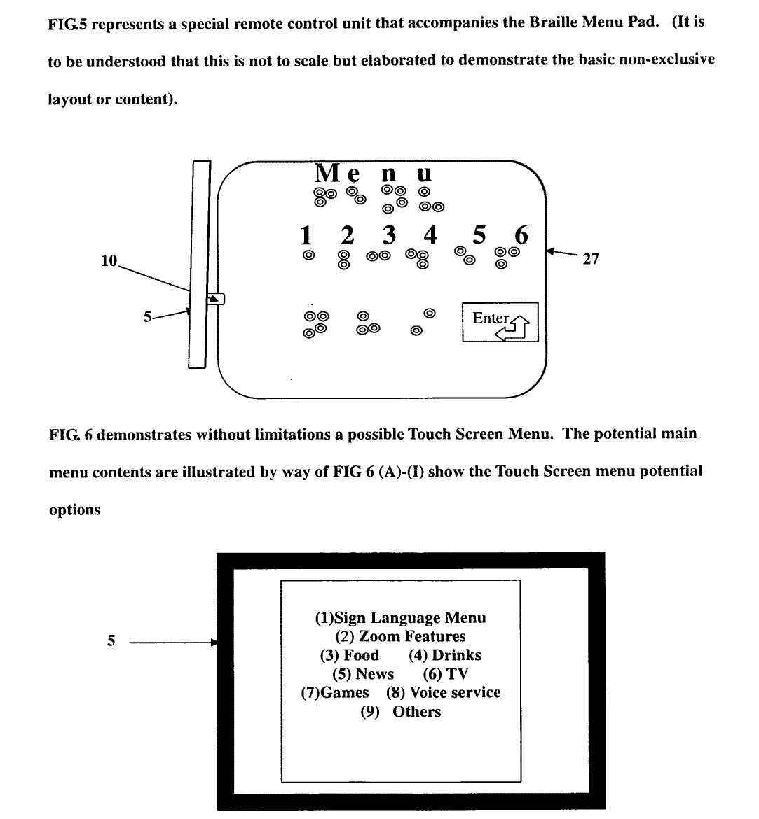

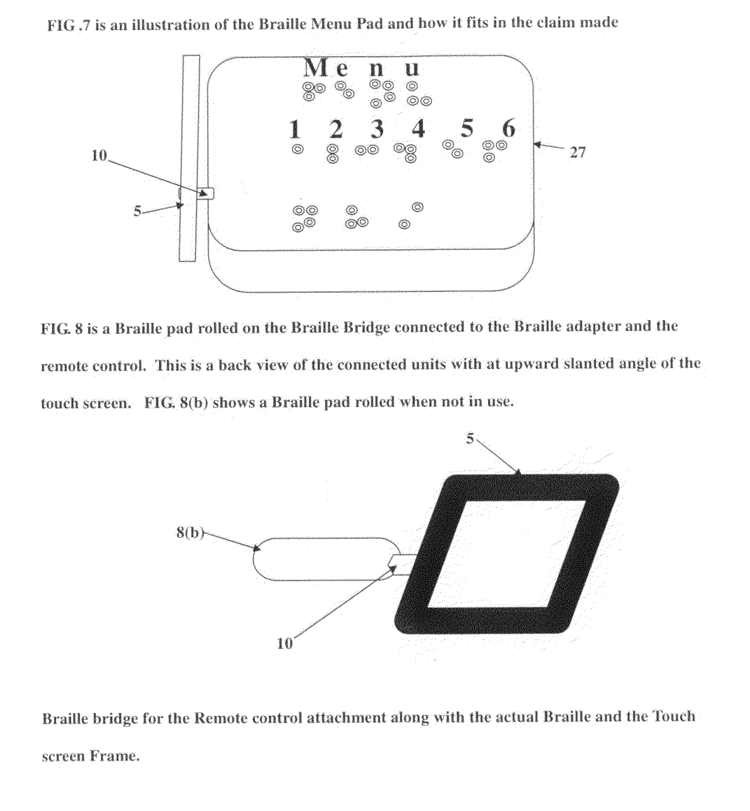

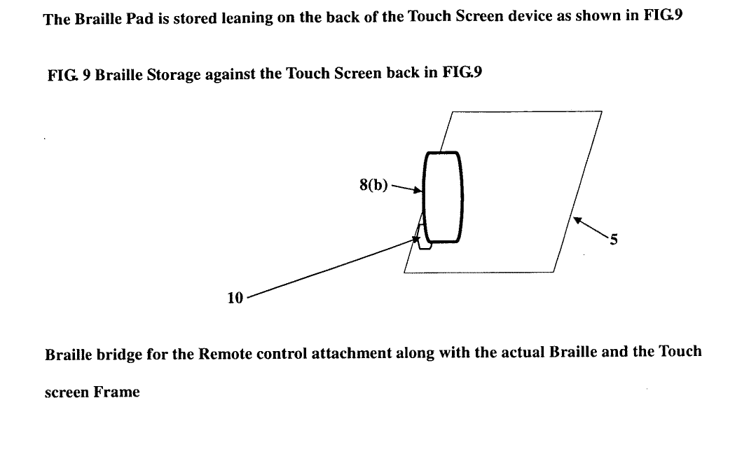

Referring to FIG. 6 (1), the service for deaf persons is by way of sign language which is presented through the touch screen menu options. The Sign Language menu is to be presented as a program activated on the touch screen using a stylus and or fingers or such tools or means that will render the screen acknowledgment and re-lay the orders made to the client-server computers as relates to the service providers communication and access to menu service.

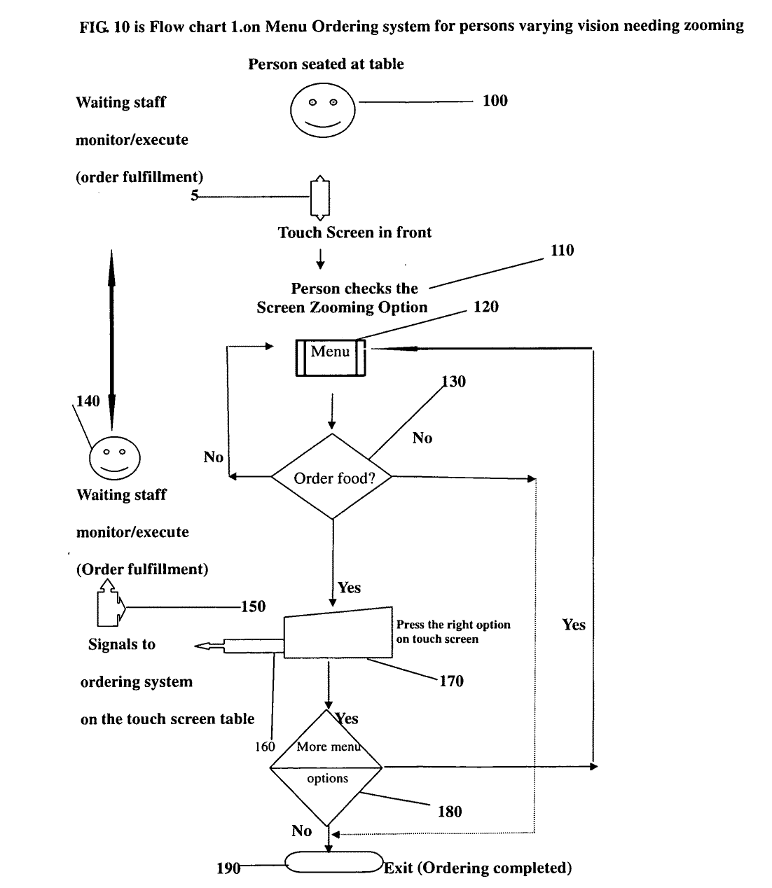

Referring to FIG. 6 (2), the service for persons with limited vision is by zooming the screen options as presented through the touch screen menu options. Further demonstration of this is presented in form a flowchart in FIG. 10 Flowchart no. 1 for demonstrative purposes only. Such person will use the regular screen to be presented as an program activated on the touch screen using a stylus and or fingers or such tools or means that will render the screen acknowledgment and re-lay the orders made to the client-server computers as relates to the service providers communication and access to menu service.

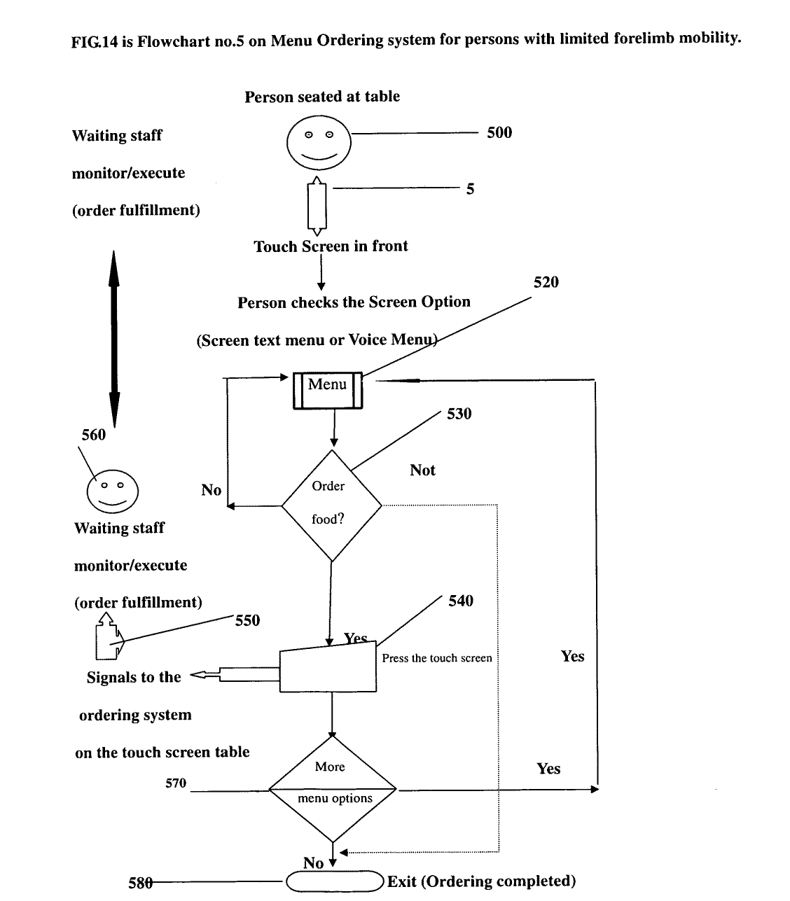

For persons not endowed with good forelimb mobility the touch screen requires less energy and inconvenience. Further, it renders itself more flexible in terms of touching the menu options other than having to explain to another person taking orders. However, the option to use the touch screen menu options could be substituted with the voice menu options without limitation. For illustrative purposes, the potential logical ordering steps are presented in FIG. 14 Flowchart no. 5.

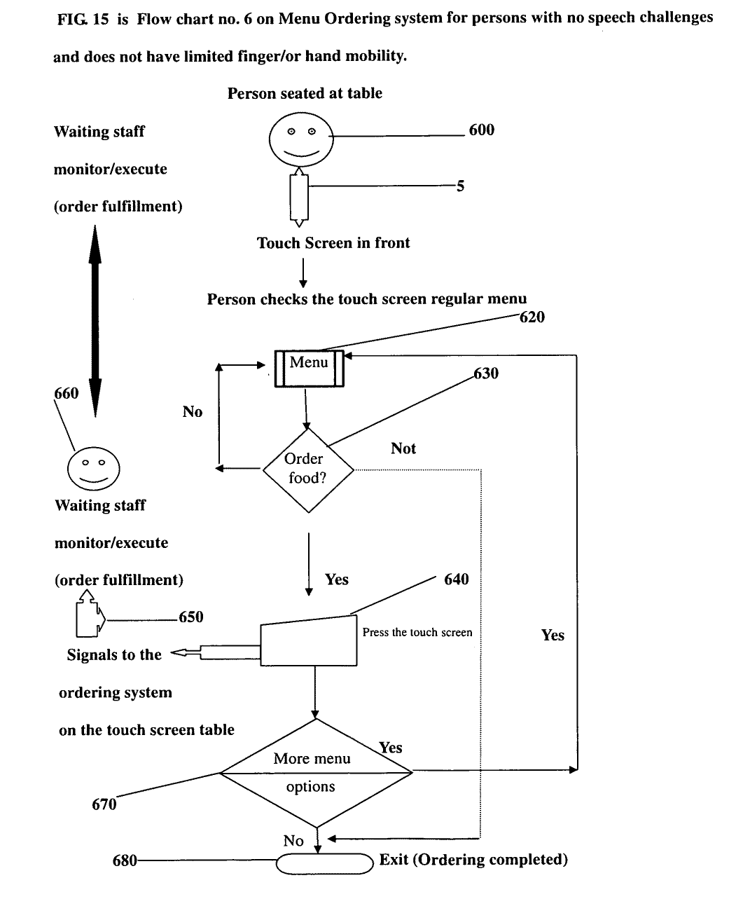

Referring to FIG. 15 Flowchart no. 6, persons without any special needs in ordering from the menu options presented on the touch screen. Further, it renders itself more flexible in terms of touching the menu options other than having to explain to another person taking orders. However, the option to use the touch screen menu options could be substituted with the voice menu options without limitation. For illustrative purposes, the potential logical ordering steps are presented in FIG. 15 Flowchart no. 6 and also FIG. 6 (A) TO (I) and beyond.

It fits in with service industry tools facilitating order service in such places like the restaurants, hotels, other food ordering and even outdoor entertainment. It is a one stop-shop integrated tool applicable to any at table self-service that could cater for touch screen service and affiliated communication accessories. This invention is in the consumer electronics technical field of portable touch screen consumer menu selection devices which link to a primary server or inter-client-server service as indicated in the illustrative drawing FIG. 1.

The device is relatively within the small portable computer devices range in size and can be customized in size to meet customer's preference. The anticipated device weight is subject to the material used by the manufacturer of the component parts but within the principles prescribed in the utilization of this device. The specific gravity of the component material for the device is not a matter covered by this invention. This self-service table-top touch screen menu digital system is highly portable and designed be operated with ease by dining table guests and restaurant staff. It comes with a total customer control features and also self-entertainment customizable software applications. For security, the device is supplied with inbuilt security tools supported by an external in-house programmable security system. The device offers a total self-service to guests in selecting their food, entertainment and payment card service.

In its broad embodiment, the present invention brings a new way of doing business in the hospitality industry and in-restaurants. Customers take control of their interaction with the hospitality staff. It minimizes social challenges that customers challenged in seeing and hearing face in restaurants. It minimizes language/accent barrier communication, hence offering an equitable entertainment and service experience in public dining places.

Broadly, the self-service digital menu device can be elevated on the table or docked appropriately on top of the table to ensure a stable inclination that allows for good screen views. The docking and attachments will vary with the restaurant needs.

The above description of the invention allows for simple use and minimum technology induction if any, for ordinary restaurant guest use. It is the first of its kind and presently the best invention. It is hoped that it is not to be limited by the above described broad embodiment, application, and industry, but by all embodiments and methods within the scope and spirit of the invention.

The illustrations below further demonstrates the environment under which the claimed article of invention operates.

FIG. 1 shows the potential communication in Wi-Fi enabled Local Area Network (Wi-Fi LAN) where the claimed device of this application is expected to work under.

By virtue of its integration of already existing devices and technologies, this device can be upgraded or be used with or without the special needs utility components whenever needed. In this context, the special needs components include and not exclusively, the Braille attachment, the Sign Language application(s) or different types of touch screens and or keyboard(s) and related computer communication accessories. The device caters for upgradeable drivers that will enable it to integrate with plug in accessories.

This invention claims to meet expectations of those skilled in the art and also solve one of the service related communication problems. The device renders itself useful and effective in the needs of people with disabilities. It is useable in businesses and other organizations in catering for physically disabled persons. It meets utility needs of scaled up disability service needs in any given population as life changes with time even among those not born with some of the common communication disabilities. This device brings back the familiar services and the prior-enjoyment of independence that such persons need. The device manufacture which is already in consideration brings together evolving technologies which persons skilled in the art will find them unique and highly useable. It will bring such disadvantaged persons to a diverse choice of potential dining places and facilitate business communication with such persons.

In conclusion the device delivers a very crucial service to people with special communication needs at dining at services. It also relieves restaurant and other service industry players the service time involved in moving paper menu's around. The service personnel have more time to give more personalized attention. The device integration with the business computer services minimizes ordering errors. The claimed device ensures better digital documentation and recording operational efficiencies in the industry through real-time order management. It will be a one of kind device within the hospitality industry. It will bring efficiency in the at table service-oriented industry but also bring people with special needs to enjoy their independence like persons endowed with regular communication and forelimbs mobility.

The Drawings Below are Exhibits of the Device from Different Views.

FIG. 2 shows the basic front view of the Self-Service Digital Table-Top Menu Ordering

Device Touch screen menu options and accessories. This is a front View tilted vertically on the stand.

FIG. 3 shows a scaled back view of the Self-Service Digital Table-Top Menu Ordering

Device of the present invention. This shows alternative vertical positioning of Self-Service Digital Table-Top Menu Ordering Device of the present invention on a table.

### Backside View Showing Ventilation and Battery Location and AC Power Adapter

FIG. 4 shows a scaled back vertical positioning view of the present device with arrows showing ventilation area, the Lithium Battery pack enclosure and the USB power adapter for charging the device battery unit. This excludes parts shown in FIG. 3.

### DETAILED DESCRIPTION OF THE INVENTION

The device is an electronic portable Self-Service Digital Table-Top Menu Ordering Device for making orders at restaurant dining tables, other hospitality service or situations where people need to have self-service points at table. Persons of ordinary skill in the art will realize that the drawings and explanations made below here serve to illustrate and educate on the invention and this is in no way limited to the presentation herein. Other embodiments of this invention will be readily present themselves to such persons who may have access to this disclosure and usage. The description is fitting in the context of emerging small consumer portable device technologies and their application.

The invention here claims that the device is made of integrating tools to create a one-stop shop for at table paperless self-selection service including and not limited to the blind, the deaf and other users with physical hand challenges. The invention replaces the use of paper menus that are often complicated to handle, get too dirty and tear a lot not to mention the paper consumption known consumer and environmental effects. This invention enhances the services of already existing manual or digital ordering systems from a diverse customer needs strategy by letting the customer take charge of their orders. It will be the first generation of its kind in the market and industry given the fact that it brings together the special needs tools. It is limited to the principle of utilization integration as one unit device and its accessories that add value to touch screen communication.

The primary device is a portable touch screen unit within a hard plastic material housing framework on the front and a plastic cover at the back as can be seen in drawing FIG. 2. The Touch Screen is fixed within the primary device as the user interface surface by way of single finger touch or using a stylus. It bears an electrical cable connection point at the lower middle bottom. The unit power consumption is adaptable to electrical power standards of the country of use by way of step down or step-up transformer but not limited to customization at the manufacture point in foregoing such power adaptation. The device comes with a special stylus pen to use and ensure a near uniform surface-pen static energy discharge. The stylus tapping is based on its singular ability to couple centrally on the adjacent sensors on the touch screen. The digital unit behind the touch screen is a system motherboard bearing all standard computer motherboard components sourced from rightful manufacturers and licensees. The motherboard has a Central Processing Unit, the Logical Unit and Memory components. The device manufacture is within the small computer device standards. The digital communication is manifested through electrical energy as an electronic device and also the Operating System for small portable digital devices. As the drawings depict in FIG. 2 there is a power switch (A power switch to turn the device on and off exists beneath the cover. There is also the Software activation powering services typical in the current marketplace operating systems. User interface is by way of the appropriate accessories, the right on screen option chosen and the underlying application software. Minimal appropriate user skills are expected on a customized unit.

While Resistive Touch Screen Technology could be applied in the claimed invention Projected Capacitive Touch technology is preferred.

Without limitations, the device comes with at least three USB 2 and 3 ports on the left and right frame. The USB ports comes with a cover.

It has an in-built Wi-Fi system in the motherboard unit. The claimed device uses Wi-Fi 802.11a wireless but it is not limited to this. It can also be built on the 802/11g wireless standard or better Wi-Fi standards. It is to be understand that wireless communication technologies is still evolving and therefore this claim may not be restricted to the current available communication technology. It stands to adapt to upgraded wireless technology.

It bears a Braille adapter and Braille Bridge that connects the Braille Pad to the primary Device. The Braille adapter and Braille Bridge are both electronic signal processing devices that communicates with the primary touch screen device through a USB port.

The device caters for common operating systems or any other software installation and integration with such tools and services that a person with skills in the art will be able to execute. Further customization to special owner-user programs is to be made by those acquiring the device to meet the goals depicted in this claim.

The embodiment of the device ergonomics and utilization is related and illustrated in the supporting drawings in this claim. The specific ergonomics and not limited to service industry only will be customized to meet restaurant and other user needs. The actual physical device is less than a 1.5 lbs in weight, bears approximately the dimensions of a portable small computer devices on the front screen panel and variable design at the back to accommodate the customizable stand or connection point relative to the dining table dimensions. It has a connection adapter to a Braille Roll (Braille pad). The device has connections for headphone, earphone, and speaker system. The digital communication is manifested through electrical energy as an electronic device and also the Operating System for small portable digital devices. As the drawings depict in FIG. 2 there is a power switch (no. 26 switch and its cover). A power switch to turn the device on and off exists beneath the cover. Software activation powering services typical in the current marketplace operating systems could be deployed. User interface is by way of the appropriate accessories, the right on screen option chosen and the underlying application software. Minimal appropriate user skills are expected on a customized unit.

This invention claims that the device communicates through a high speed Wi-Fi supported system that connects it to the restaurant computer. This caters for Local Area Network Wi-Fi with Wi-Fi Protected Access (WAP2) but also adaptable to evolving Wi-Fi security technology. Subject to country regulations the Wi-Fi is expected to have approved channels within the 2.4 GHtz and above.

The device is built on a state of the art touch screen digital menu technology. In terms of weight it is highly portable. The touch screen technology is already in the market place and it is therefore not a claim made herein.

Distinguishing the order origination is made through the wireless network management and also ordering software request on customers entering their orders. It is to be appreciated that device network management includes but is not exclusive the table location and other management issues that will enhance effective application of the device to the claims made herein.

It offers a wireless connectivity to the kitchen and Point Of Sale services but can also be customized to communicate through the USB cable.

The choice of what type of screen to adopt is to be left to the manufacturer of the ordered product. This invention supports the principle that the device described here is adaptable to evolving touch screen technology.

Physical Device Support on the Table is based on its bottom cosmetic design as illustrated in the drawing. The stand is optional and is not part of this claim. It can be attached on tables or a cable.

The electronic system unit is housed in external material is a plastic at the back and the side framework. The external framework may be made with acrylic or any other material of choice for electronic devices if need be. The front bears the touch screen and the sides have USB ports and also microphone and payment card slot. The external unit cleanliness and maintenance is subject to manufacturers' material guidelines. Device color can be varied according to clients needs and are not limited to this claim. For its electronic power, the device run on a Lithium Battery whose output capacity is matched with the system unit power requirements as per material manufacturers' specifications. The device can also use an AC adapter that is again matched with its power requirements. A USB port for its USB AC power Adapter exists which is also usable in recharging the device.

The device has special adapter to cater for the Braille pad connection, sign language and the zoom features for those with sight limitations. The primary unit will be able to communicate wirelessly with the main restaurant computer to fetch the menu services.

As earlier indicated it is also supposed to allow small wireless devices operating systems and could be modified for proprietary systems.

In the embodiment of this invention, functionality by design and use is tailored towards the end-users of the device. Broadly, the device functionality depends on the customer needs. A regular person without visual limitations will use the regular touch screen menu by tapping on the screen with a finger or a pointing pen. The selection options are customized according to the owner of the device service to be offered.

Specifically, Braille use requires a special Braille unit not subject of this specific application but rather to be a connection point for a variety of Braille menu tools through a special adapter electronic unit attached to the Touch Screen Device itself. The special Braille adapter is within the context of this claim. The Braille unit is on a rolling unit connected to the Touch screen device electronically and operated through a press button remote control-like unit. This button system is also supplemented through a remote control unit. The remote control is programmed against the ordering system in such that the numbers correspond to the menu numbers and other relevant supportive functionality. The remote control has a button to identify customer ordering by table. Specifics on such are based on the management customization and dining seating arrangement.

FIG. 5 the special remote control unit is illustrated in the FIG. 5 (not to scale but elaborated to demonstrate the basic non exclusive layout).

Instructions on how to use the device are rolled out on the touch pad roll specifically for the blind. The Braille Roll is in conformity with international Braille standard in terms of touch material and symbols of communication. While dimensional measurements are not restrictive, the Braille device is 6 inches wide and length is expected to be no more than 15 inches.

It is to be rolled width-wise. It is hooked to the Braille adapter with cord to one side of the primary touch screen unit when not in use. The Braille adapter bears a numerical digital pad like a remote control. The digital pad is calibrated in both Braille and their corresponding equivalent Roman numbers. Braille user rolls it out and makes ordering decision as depicted in the flowchart no. 1, then presses the respective corresponding menu option on the digital pad. It is to be noted that the Menu owner will have a menu to match with the easily programmable communication remote-control like device.

This invention asserts that the blind can use the Braille system along with a digital button accessory system. Braille communication with the touch screen unit is via a connector and with digital keys. The connector (Braille adapter) is connected to the Touch screen Device through a USB port and can be configured to work wirelessly.

The digital pad can also be configured to use control signaling principles. The blind person feels the menu options and presses the button. The button signal is sent to the computer hosting the primary ordering system. An acknowledgment of order receipt is made and confirmation sent back via an accessory acknowledgment button that pop up for the blind person to re-confirm and acknowledge. The same applies to the pay system pad. The logical usability of the device is depicted in the flowcharts 1-6 illustrations enlisted in this document under the claim made herein.

The USB ports are for connecting the accessories applicable to the programs installed. The USB and microphone ports are not subjects of this invention claim. Rather these are services rendered through existing marketplace products and inventions and to be tailored by the manufacturer.

Device accessibility for persons with partial visual limitation is via adaptive screen character size zooming feature. This is basically software driven service. The methodologies and the associated software involved in screen objects sizing are not part of this claim either. However, they contribute to one of the ultimate goals of the claim made herein.

The device invention claim to cater for those hard of hearing or those who might prefer to use a voice system is through an earphone connection port on the upper frame. The port is to be connected to a headphone or earphone of choice by the person or persons offering the table-top self-service device. There is also a voice activated menu system for those who prefer the voice system as shown in touch screen options.

For the completely deaf but with normal visual capability, Sign Language is envisioned through the touch screen options standard Sign Language Provision is catered for on the Touch Screen menu options. Modifications on the sign language may be made to meet country by country needs and even specific language symbols to cater for cultural variations. Digital image processing tools could be adapted into the device programs for communication.

It is to be noted that description here, for the purpose of sole explanation and insight pertaining to this invention is in itself not exclusive in the technical details of this claim. It is possible to have modifications and still retain the goals within of the claims made herein. Whatever these modifications are, it will be apparent to one skilled in the art of small touch screen devices that some specific details will fall under manufacturers and user specifications. In the drawings such presentation is made through dotted lines. Dotted lines indicate the areas where this invention interacts with other inventions that are not subject of this claim. The foregone description of specific embodiments of this invention is presented for the purpose of illustration and description. They are not intended to be exhaustive or to limit the invention to the precise forms disclosed. The presentation of the claim herewith is made to the best possible principle embodiment of this invention so that those skilled in the art can be able to utilize this invention effectively.

In addition, the device operations specific to a client needs including special needs persons have been figuratively illustrated with special perception on the embodiments claimed in this invention. The logical details and performance associated with the device assembly while expected to be understood by those skilled in the art pertaining to this kind of invention is in no way limited to the presentation made herein.

Without limitations the embodiments of this invention present a substantiated logistics by way of illustrated flow charts and drawings on potential operation. The Flowcharts are by no means drawn to scale. Rather it is an exhibit of possible logical decision ordering steps or process in interacting with the device. Specifications and functionality are not exhibited herein.

In conclusion, a person will observe that the claim made here brings into the service industry a more efficient way of ordering services. In addition to efficiency and other useful implications of the claim, it gives persons with special needs equity and removes excess dependency in critical things during selection of their orders. The claim relieves those assigned ordering service of the stress associated with ordering mistakes. Such persons getting the relief may use that time to build better human-human relationships while avoiding conflicts and often business losses associated with customer-dissatisfaction. It enables fully automated ordering systems that might increase efficiency in resource planning where orders are involved.

### MAIN REFERENCE NUMERALS

1) Server
2) Client-Server (kitchen terminal)
3) Wi-Fi
4) Hot Spot
5) Touch Screen Device (5a) Credit Card (Point of Sale) Swipe slot
6) Antenna
7) Microphone
1. /Headphone jack
8) (a) Braille Menu pad (b) Braille pad rolled when not in use
9) Other Braille technologies
10) Braille Bridge
11) Device docking stand on the table
12) Electric Power Cable
13) Connection mechanism for the Device to the stand
14) Reset Button
15) USB ports cover
16) Vendor Information sticker
17) Ethernet Network interface port cover
18) Ethernet port uncovered
19) USB ports
20) Ventilation
21) Groove for Battery opening
22) Battery Pack Enclosure
23) AC power adapter
24) Electrical cord
25) Power Port
26) Touch Screen frame
27) Remote Control Unit (Braille Device)

1. The Self-Service Digital Table-Top Menu Ordering Device is a new entry device to be used by guests at table in service ordering and that it offers a special touch screen customized service not accessible to people with special needs. Its focus is the physical digital device assembly and the intended use. This claim while not exclusively limited is enhanced by the added elaborative scope within the claim here below on the device, its assemblage, communication and applicability.

2. The Self-Service Digital Table-Top Menu Ordering Device of claim 1, wherein the device comprised of its integrated design, its communication interface within a Wi-Fi enabled Local Area Network and by potential it caters for the special needs persons as well as persons without such limitations like vision, hearing or hand or finger mobility in ordering for services for example food in restaurants. The claim is made that this is not limited to food services ordering.

3. The Self-Service Digital Table-Top Menu Ordering Device of claim 1, wherein the device has an integrated Touch Screen unit belonging to small computer-related device with pre-determined dimensions, size and weight.

4. The Self-Service Digital Table-Top Menu Ordering Device of claim 1, wherein the device integration while not limited comprises of the accessories like the Braille Pad, its Braille Bridge, The Braille Remote Control, the USB ports, the Microphone ports, the Sign Language, Zooming feature, antennae, Wi-Fi communication capability, Voice services, the Screen Menu Options underlying the Touch Screen, actual Touch screen device with its underlying functional hardware.

5. The Self-Service Digital Table-Top Menu Ordering Device of claim 1, wherein the device uses digital communication in the actual communication between the electronic components of the integrated device and the primary ordering computer and this is facilitated through a hot spot accessible to the device.

6. The Self-Service Digital Table-Top Menu Ordering Device of claim 1, wherein the device will be customized through applicable software both at the Operating system, software developed to work on such operating systems and that the device parts, technologies and software employed can be adapted with changing digital technology.

7. The Self-Service Digital Table-Top Menu Ordering Device of claim 1, wherein the Touch Screen has Braille Bridge that is adaptable to other Braille digital menu systems.

8. The Self-Service Digital Table-Top Menu Ordering Device of claim 1, wherein the device is operated according to special logistics based on a person's ability to see, hear or move hands and or fingers.
